(19) United States
(12) Patent Application Publication
(10) Pub. No.: US 2006/0146232 A1
(43) Pub. Date: Jul. 6, 2006

(54) Passive matrix display and manufacture method

(76) Inventors: Chi-Chang Liao, Tainan City (TW); Yan-Rung Lin, Ping Tung Hsien (TW); Jau-Min Ding, Taipei City (TW); Yi-An Sha, Taipei City (TW)

Correspondence Address: RABIN & BERDO, P.C., Suite 500, 1101 14 Street, N.W., Washington, DC, 20005, US

(21) Appl. No.: 11/287,302

(22) Filed: Nov. 28, 2005

(30) Foreign Application Priority Data
Dec. 31, 2004 (TW) 93141908

(51) Int. Cl. G02F 1/1333

(52) U.S. Cl. 349/86

(57) ABSTRACT

A passive matrix display and manufacture method, which makes a various microstructure on the general substrate or flexible substrate, coat or inkjet a conductive layer between the microstructures, fill a plurality of display media in the gaps. The microstructure provides stronger strength for the cell gap. The device and method avoid the increased driving voltage arising from the residual layer in the embossing process.

### BACKGROUND OF THE INVENTION

1. Field of the Invention

The present invention relates to a passive matrix display and manufacture method, which makes a passive matrix display microstructures on an upper substrate, a lower substrate, coating a conductive layer on the residual layer, and assembling the upper and lower substrates to produce a passive matrix display.

2. Description of Related Art

In general, the structure of a display device adopting an embossing technology usually is disposed with a conductive layer before performing the embossing process, and the residual layer produced by the embossing process will increase the drive voltage of the display device.

U.S. Pat. No. 6,751,008, entitled “Electrophretic display and novel process for its manufacture”, issued to Sipix Imaging Inc., successfully adopts a roll-to-roll process and an embossing technology to produce an architecture that has microcups without filling in aligned display media.

U.S. Pat. No. 5,956,112, entitled “Liquid crystal display and method for manufacturing the same”, issued to Sharp Company, produces a stripe structure on a side of a substrate along a certain specific direction, and then utilizes a phase separation method to grow a polymer stripe structure perpendicular to the stripe structure and define a sealed structure and adhere the upper and lower substrates.

An excessively large pressure applied to a flexible substrate during the embossing process may easily result in a crack of the conductive layer, and the LCD produced by the phase separation method has poor contrast. These prior arts thus have certain limitations on their applications.

### SUMMARY OF THE INVENTION

To overcome the shortcomings of the prior art LCD manufacturing processes, the inventor of the present invention proposes a passive matrix display and manufacture method.

Therefore, it is a primary objective of the present invention to provide a manufacture method of a passive matrix display, which makes a various microstructure on the general substrate or flexible substrate, and then coat or inkjet a conductive layer between the microstructures, and combines the substrates. Such a microstructure acts as the alignment layer or as a bank for color filter. Since the microstructures are not sealed and it provides strength for a cell gap when the upper and lower substrates are combined, display media can flow therein as they are filled.

To achieve the foregoing objective, the present invention proposes a passive matrix display and manufacture method comprising the steps of preparing an upper substrate and a lower substrate; producing a plurality of microstructures on the upper substrate, the lower substrate or both; forming a conductive layer between the microstructures on a residual layer; disposing an alignment layer on the conductive layer for alignment treatment; combining the upper substrate and the lower substrate, such that a gap is formed between the microstructures of the upper substrate and the microstructures of the lower substrate; and filling a plurality of display media in the gaps. Or the filling step is to fill a plurality of display media in the gap between the microstructures before the upper substrate and the lower substrate are assembled.

To achieve the foregoing objective, the present invention also proposes a passive matrix display comprising an upper substrate and a lower substrate; a plurality of microstructures produced on the upper substrate, the lower substrate or both; a color filter formed on the microstructures; a conductive layer formed between the microstructures; an alignment layer disposed on the conductive layer; a cell gap formed between the upper substrate and the lower substrate and a plurality of display media filled in the cell gap between the upper substrate and the lower substrate.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIGS. 1A to 1G show the process of manufacturing a passive matrix display of the present invention;

FIGS. 2A and 2B are side views of microstructures of different heights of the present invention;

FIGS. 3A to 3C are top views of non-continuous microstructures of upper and lower substrates of the present invention;

FIGS. 4A to 4C are top views of non-continuous microstructures of upper and lower substrates of the present invention;

FIGS. 5A to 5C are top views of non-continuous microstructures and continuous microstructures of upper and lower substrates of the present invention;

FIG. 6 is a top view of non-continuous microstructures and continuous microstructures of another form of upper and lower substrates after combining with each other in accordance with the present invention; and

FIG. 7 is a top view of a sealed structure formed by combining the structures as depicted in FIGS. 1 to 6 by polymerization in accordance with the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention. However, the drawings are provided for examples only and not intended to limit the present invention.

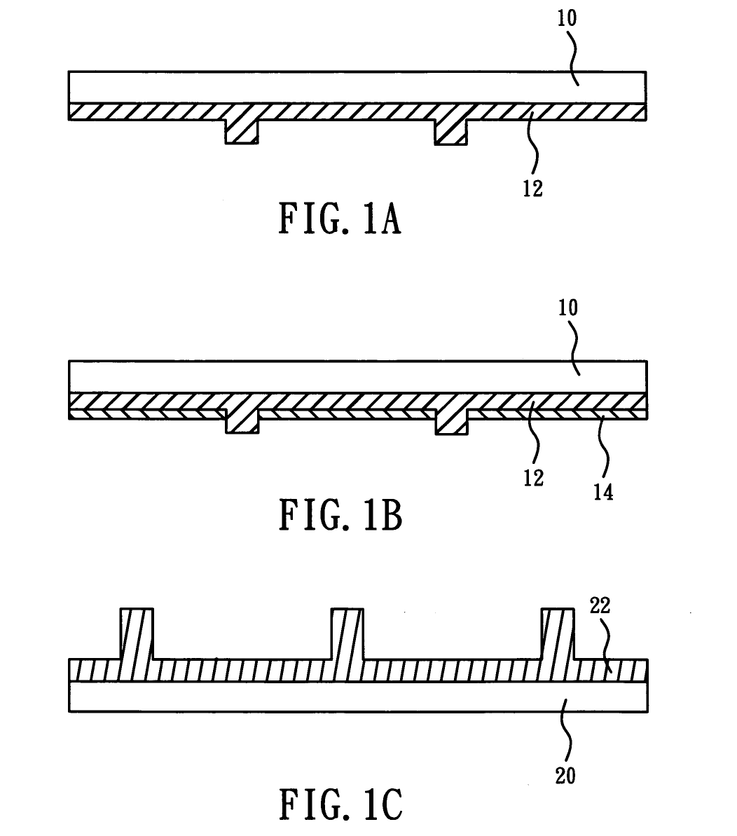

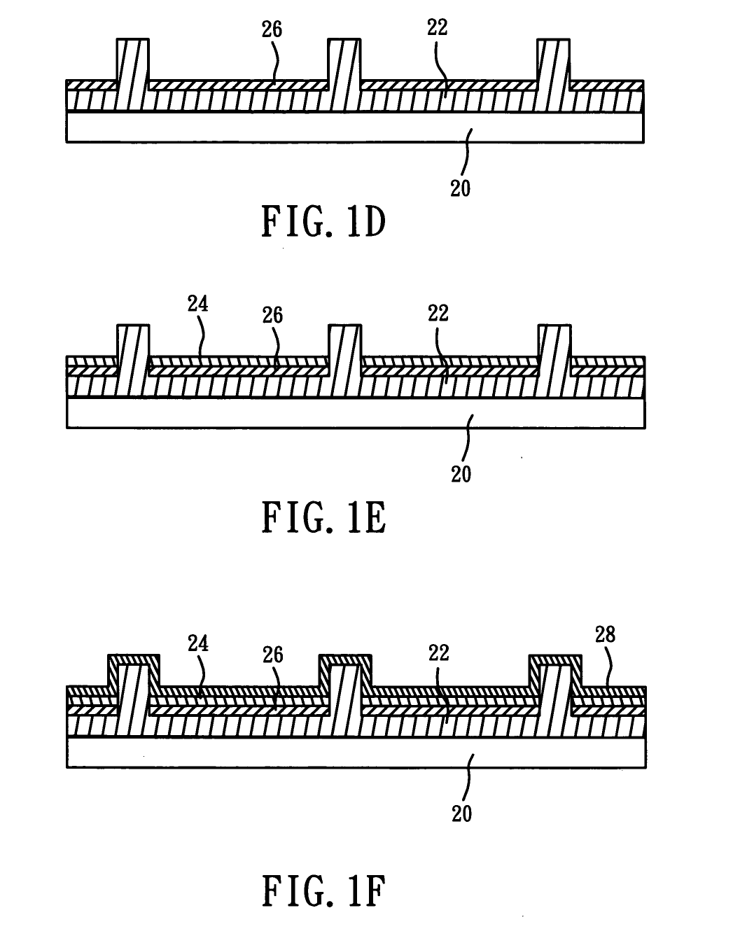

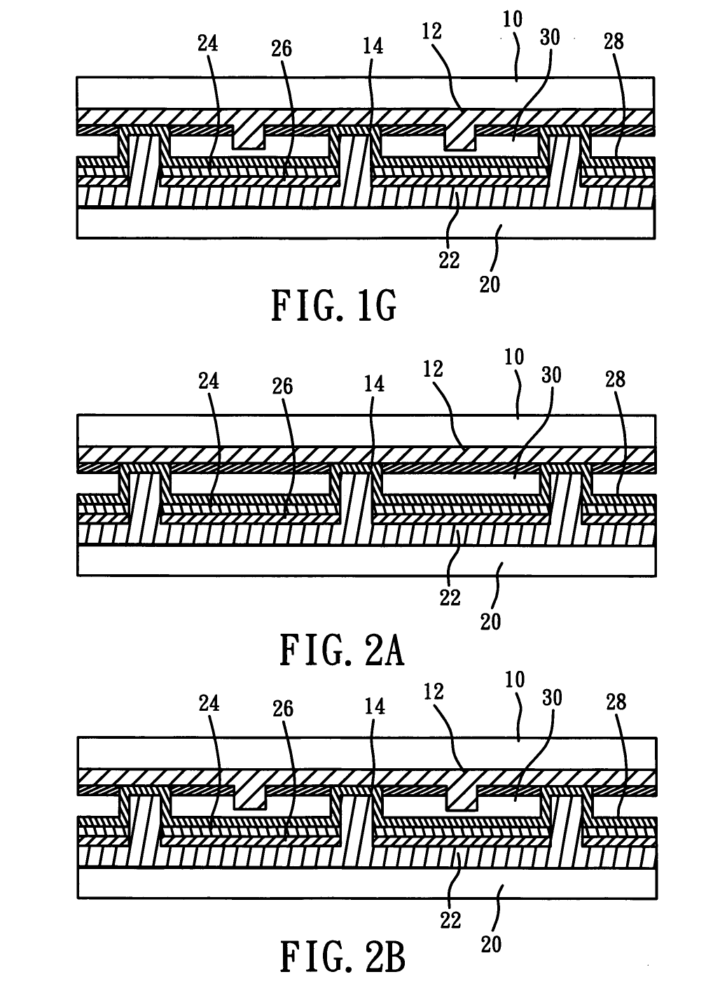

Reference is made to FIG. 1F for a passive matrix display in accordance with the present invention. And reference is made to FIGS. 1A to 1F for the manufacturing procedure of a passive matrix LCD in accordance with the present invention, and the procedure is described below.

FIG. 1F shows the structure of a passive matrix display, comprising an upper substrate 10 and a lower substrate 20. The upper 10 and lower substrates 20 are glass substrates or flexible substrates. Pluralities of microstructures 12, 22 are produced on the upper 10 and lower substrates 12 or both. The microstructures 12, 22 are formed by photo (or heat) polymerization, printing or embossing. The microstructures 12, 22 act as spacers for the gap cell, alignment layer, and/or microwalls. The microstructures 12, 22 are, for example, a plurality of non-continuous microstructures or a plurality of continuous microstructures. The non-continuous microstructures are circular, rectangular, or other geometric shapes.

A conductive layer 14 is formed on the microstructures 12 of the upper substrate 10, and a conductive layer 24 is formed on the microstructures 22 of the lower substrate 20. A color filter 26 is formed on the microstructures 22 of the lower substrate 20. An alignment layer 28 is coated on the conductive layer 24 for alignment. A plurality of fluid media is filled into a gap between the microstructures 12 of the upper substrate 10 or the microstructures 22 of the lower substrate 20 by filling, ODF, or coating. A sealed structure (not shown) is formed by a plurality of polymers which is added a plurality of initiators and going through a polymerization process.

Reference is made to FIGS. 1A to 1F for the manufacturing procedure of a passive matrix LCD in accordance with the present invention.

FIGS. 1A and 1B show the manufacture method of an upper substrate. In FIG. 1A, an upper substrate 10 made of a glass substrate or a flexible substrate is provided, and a plurality of microstructures 12 is produced on the upper substrate 10. The microstructures 12 are formed by photo (or heat) polymerization, printing or embossing. The microstructures 12 are, for example, a plurality of non-continuous microstructures or a plurality of continuous microstructures. The non-continuous microstructures are circular, rectangular, or other geometric shapes. The height of the microstructures is equal to or smaller than the cell gap, and the microstructures act as spacers for the gap cell, alignment layer, and/or microwalls. The microstructures on a substrate are all arranged in the same direction with linearly arrangement between the conductive layers, and thus electrodes in row can be produced. If a rubbing method is adopted for the alignment, the rubbing direction is parallel to the direction of the microstructures to avoid the occurrence of defects.

In FIG. 1B, a conductive layer 14 is formed on the microstructures, where the conductive layer 14 is produced by a sputtering or an inkjet process, and the conductive layer acts as a passive matrix electrode.

FIGS. 1C to 1E show the manufacture method of a lower substrate. In FIG. 1C, a lower substrate made of a glass substrate or a flexible substrate is provided, and a plurality of microstructures 22 is produced on the lower substrate 20. The microstructures 22 are produced by photo or heat polymerization, printing, or embossing process. The microstructures 22 are, for example, a plurality of non-continuous microstructures or a plurality of continuous microstructures. The non-continuous microstructures are circular, rectangular, or other geometric shapes. The height of the microstructures 22 is equal to or smaller than the cell gap, and the microstructures 22 act as spacers for gap cell, alignment layer, and/or microwalls. The microstructures 22 on a substrate are all arranged in the same direction with linearly arrangement between the conductive layers, and electrodes in row can be produced. If a rubbing method is adopted for the alignment, the rubbing direction is parallel to the direction of the microstructures to avoid the occurrence of defects.

In the manufacturing procedure of the plurality of microstructures 12, 22, a sealed structure is produced by a phase separation method, and a plurality of initiators and polymer monomers are added to mix with the display fluid media and dropped, coated, or filled onto the microstructures. The sealed structure can be formed by a mask or other patterns to control an illuminating position for the phase separation.

In FIG. 1D, a color filter 26 is formed on the microstructures 22 of the lower substrate 20. The color filter 26 is produced by an inkjet process. In FIG. 1E, a conductive layer 24 is formed on the color filter 26. The conductive layer 24 is produced by a sputtering or an inkjet process, and the conductive layer acts as a passive matrix electrode.

FIG. 1F, an alignment layer 28 is coated on the conductive layer 24 for alignment.

FIG. 1G, shows the manufacturing procedure for assembling the upper substrate 10 and the lower substrate 20, such that a gap 30 is formed between the microstructures 12 of the upper substrate 10 and the microstructures 22 of the lower substrate 20 after the upper and lower substrates 10, 20 are assembled, and this combining procedure adopts a traditional adhesion method. A plurality of display fluid media is then filled into the gap. The filling is achieved by a vacuum filling process, and the display fluid medium is a liquid crystal. The microstructures are not sealed when the upper and the lower substrates are combined, and the display fluid media can flow therein.

In view of the description above, the manufacturing procedure of a passive matrix display in accordance with the present invention primarily utilizes the vacuum filling process. If an ODF or a coating method is adopted, the plurality of display fluid media is filled between the microstructures of one of the substrates (the upper substrate or the lower substrate) before combining the upper and lower substrates as shown in FIG. 1F, and the display fluid medium is a liquid crystal.

Reference is made to FIGS. 2A and 2B for side views of the microstructures with different heights. The height of the embossed structures is equal to the cell gap when the upper 10 and lower 20 substrates are compressed and combined as shown in FIG. 2A. By then, the structure can support the cell gap and act as a spacer. FIG. 2B shows a side view of the embossed structures having a height smaller than or equal to the cell gap. By then, the structure can act as a wide-view-angle protrusion and spacer.

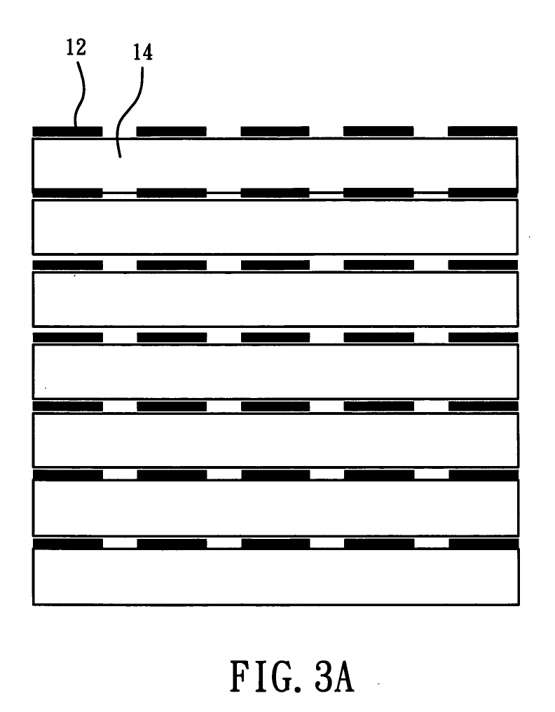

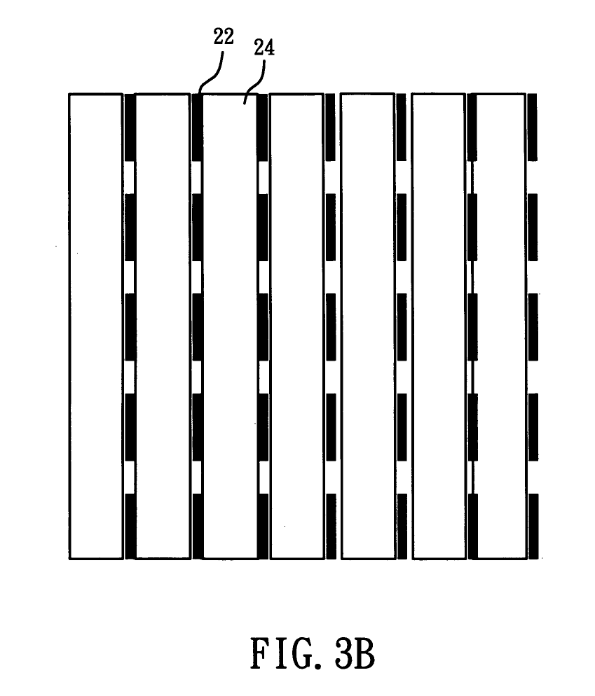

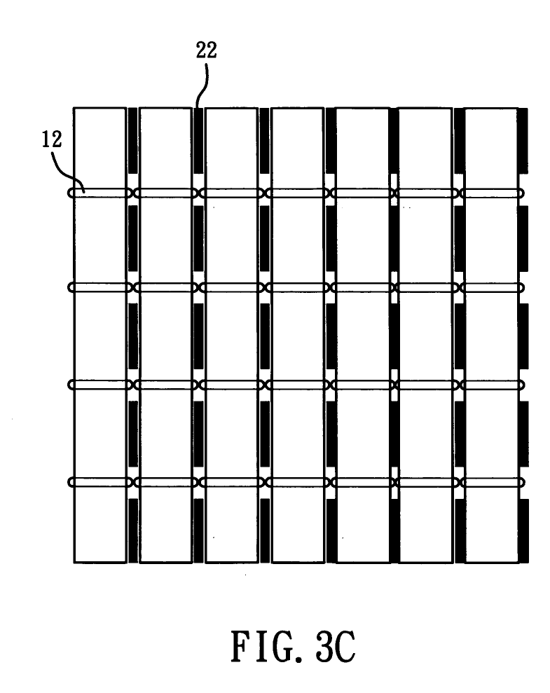

Reference is made to FIGS. 3A to 3C for top views of the non-continuous microstructures of the upper and lower substrates. FIG. 3A shows a top view of the non-continuous microstructures of the lower substrate. The non-continuous microstructures 12 are in the shape of a rectangular bar, and a conductive layer 14 is formed between the non-continuous microstructures by a sputtering or an inkjet method. FIG. 3B shows a top view of the non-continuous microstructures of the upper substrate. The non-continuous microstructures 22 are in the shape of a rectangular bar, and a conductive layer 24 is formed between the non-continuous microstructures by a sputtering or an inkjet method. FIG. 3C shows a top view of the non-continuous microstructures of the upper and lower substrates after the upper and lower substrates are combined. The non-continuous microstructures 22 of the upper substrate and the microstructures 12 of the lower substrate are in the shape of a rectangular bar.

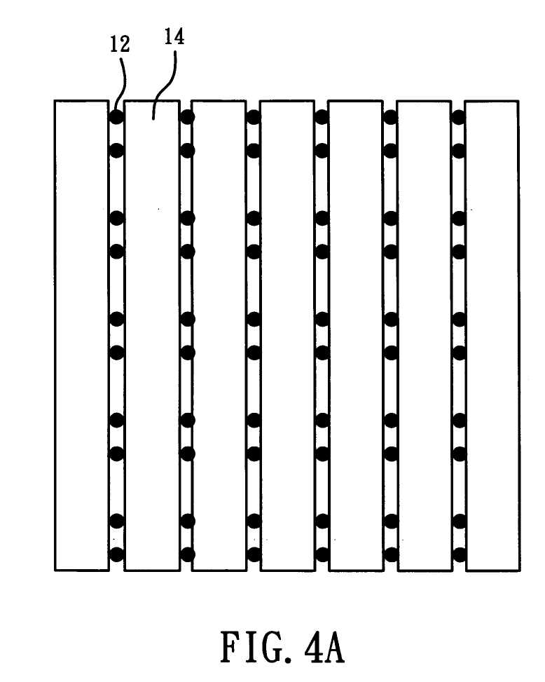

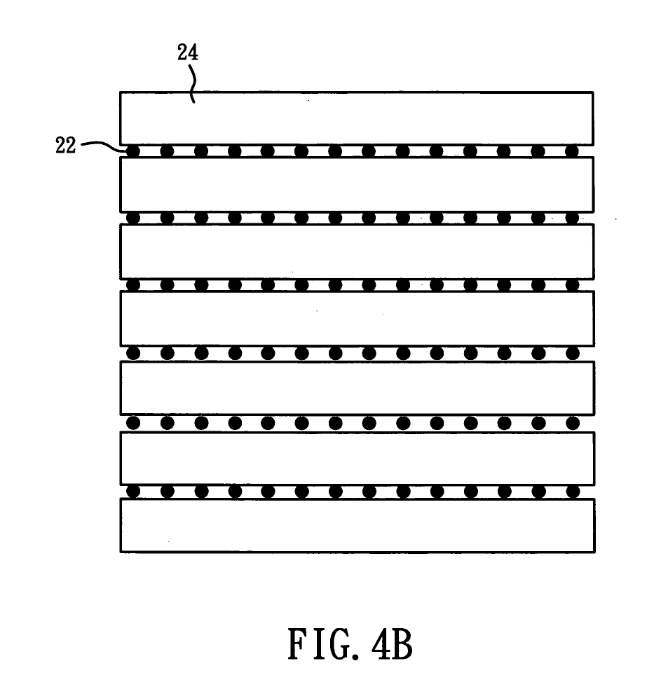

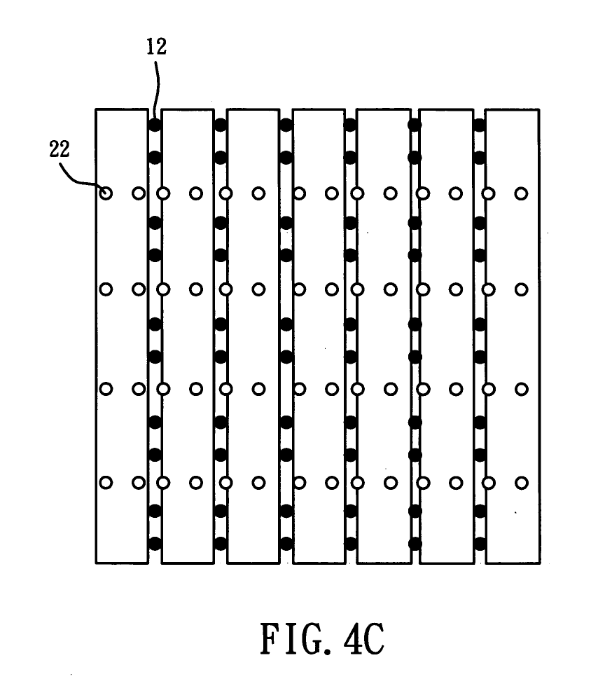

Reference is made to FIGS. 4A to 4C for top views of non-continuous microstructures of the upper and lower substrates. FIG. 4A shows a top view of the non-continuous microstructure of the upper substrate. The non-continuous microstructure 12 is circular, and a conductive layer 14 is formed between the non-continuous microstructures by a sputtering or an inkjet method. FIG. 4B shows a top view of the non-continuous microstructure of the lower substrate. The non-continuous microstructure 22 is circular, and a conductive layer 24 is formed between the non-continuous microstructures by a sputtering or an inkjet method. FIG. 4C shows a top view of the non-continuous microstructure of the combined upper and lower substrates. The non-continuous microstructure 12 of the upper substrate and the non-continuous microstructure 22 of the lower substrate are in a rectangular bar shape.

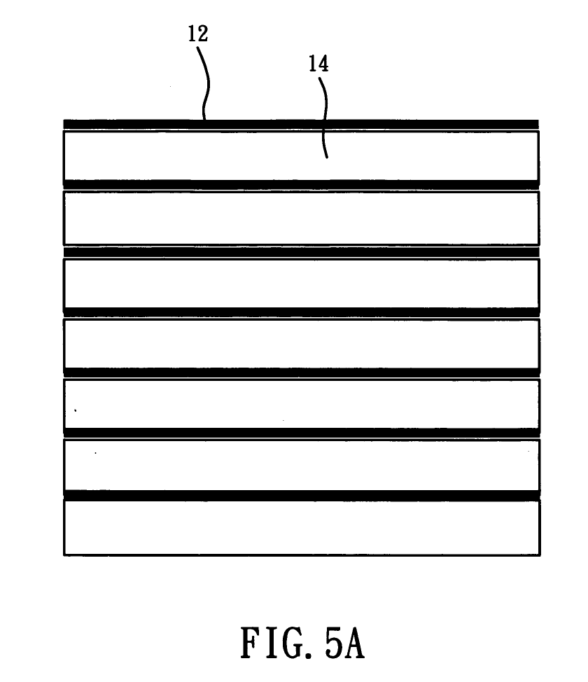

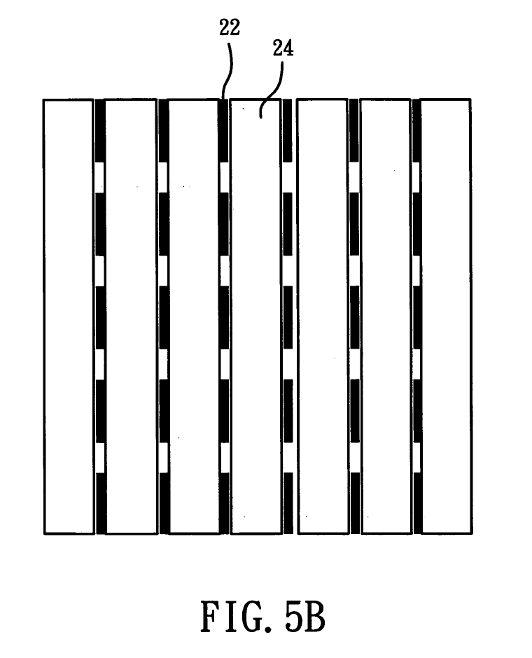

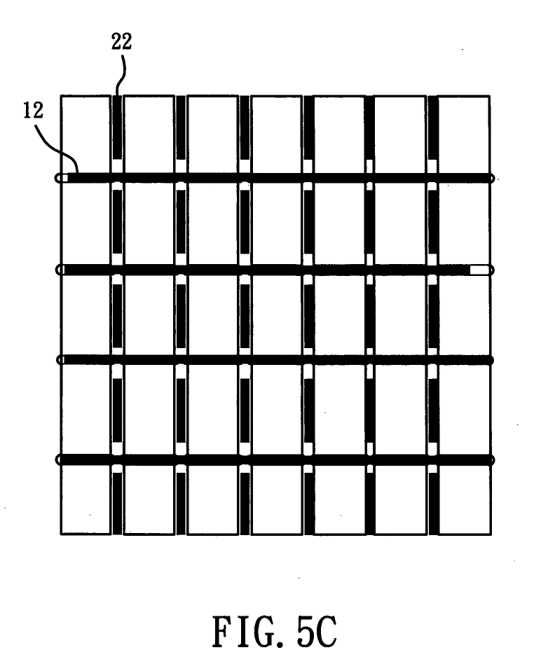

Reference is made to FIGS. 5A to 5C for a top view of microstructures with different shapes of the upper and lower substrates. FIG. 5A shows a top view of continuous microstructure of the lower substrate. The non-continuous microstructures 12 is in the shape of a continuous long bar, and a conductive layer 14 is formed between the non-continuous microstructures by a sputtering or an inkjet method. FIG. 5B is a top view of non-continuous microstructure of an upper substrate. The non-continuous microstructure 22 is in the shape of a continuous long bar, the non-continuous microstructure is in the shape of a continuous long bar, and a conductive layer 24 is formed between the non-continuous microstructures by a sputtering or an inkjet method. FIG. 5C is a top view of non-continuous microstructure with different shapes of the combined upper and lower substrates. The non-continuous microstructure 22 of the upper substrate and the non-continuous microstructure 12 of the lower substrate are in the shape of a continuous long bar.

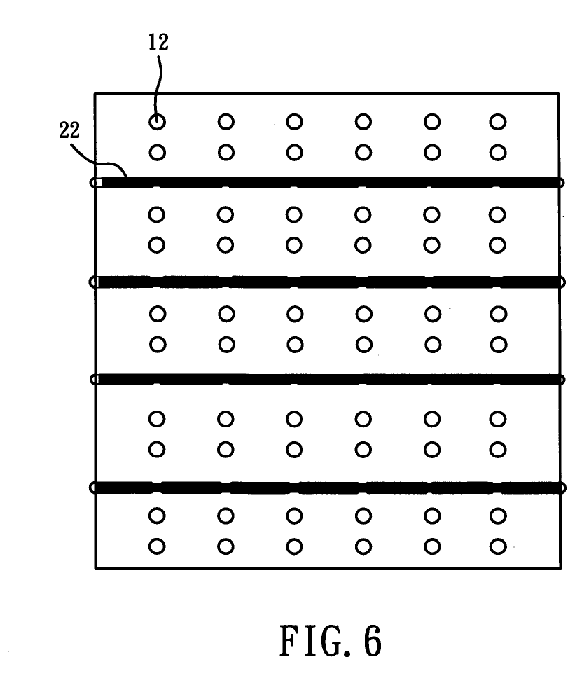

Reference is made to FIG. 6 for a top view of the continuous microstructures 12 and the non-continuous microstructures 22 of the combined upper and lower substrates according to another form. The non-continuous microstructure is circular.

The arrangements of the continuous and non-continuous microstructures are not limited to those depicted in FIGS. 1 to 6. The arrangement of the microstructures allows the upper and lower substrates to be installed in opposite directions.

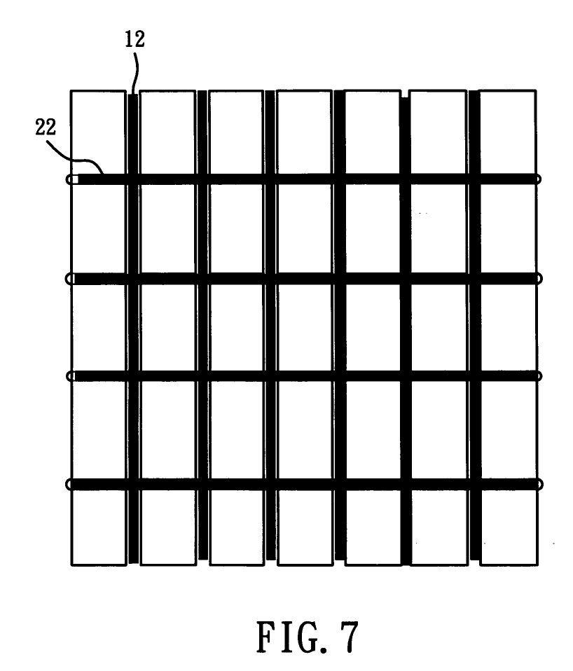

Reference is made to FIG. 7 for a top view of a sealed structure produced by the combining procedures as shown in FIGS. 1 to 6 and then by the phase separation method. The sealed structure is formed a polarity of polymer by a phase separation method.

If the microstructures in the display are produced by an embossing process, the embossing process is performed generally after a conductive layer is disposed. The residual layer in the embossing process will increase the driving voltage and an excessively large pressure applied to a flexible substrate during the embossing process may cause the conductive layer to crack easily. Therefore, the present invention produces various microstructures on a general substrate or a flexible substrate, and then disposes a conductive layer between the embossed structures by sputtering or inkjet, so as to prevent an increase of driving voltage caused by the residual layer in the embossing process.

In the meantime, the present invention also can utilize a phase separation method to combine an upper substrate and a lower substrate and give a stronger support to the cell gap. The microstructures on the same substrate are arranged in the same direction, and thus electrodes in rows can be produced. If a rubbing method is used for the alignment, then the rubbing direction is parallel to the direction of the arrangement of microstructures to avoid the occurrence of defects. Such a structure acts as the alignment layer or as a bank for color filter. Since the embossed microstructures are not sealed when the upper and lower substrates are combined, display media can flow therein as the they are filled.

A regular LCD substrate or a flexible display substrate requires certain microstructures to act as spacers, alignment layer, or banks for a color filter. Embossing is a good method for producing microstructures, which does not require many complicated steps as in photolithography process. The manufacturing process is thus quick and can reduce the manufacturing time and cost. If the structure of the upper and lower substrates goes with the phase separation method, the upper and lower substrates can be adhered closely with each other and a stronger support between the cell gaps is achieved.

Display manufacturers hope to produce the next-generation flexible display by a low-temperature, low-vacuum (or vacuum free), printable process and use a roll-to-roll method for the manufacture, and thus the embossing technology is a good choice. It is expected that the third generation display (flexible display) will use a flexible substrate to substitute the fragile glass substrate. Therefore, the flexible display product will be lighter and thinner, and its flexibility makes the product more portable. In the meantime, the product is easy to manufacture and cut into different shapes to provide diversified appearances and freedoms for the design. Such product not only substitutes the second generation flat panels, but also offers a good opportunity for the developing market.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A passive matrix display, comprising of:
an upper substrate and a lower substrate;
a plurality of microstructures on said upper substrate, lower substrate or both;
a conductive layer between said microstructures; and
a plurality of display media filled in a cell gap between said upper substrate and said lower substrate.

2. The passive matrix display of claim 1, wherein said upper and lower substrates are glass substrates or flexible substrates.

3. The passive matrix display of claim 1, wherein said microstructures are a plurality of non-continuous microstructures or a plurality of continuous microstructures.

4. The passive matrix display of claim 3, wherein said non-continuous microstructures are circular, rectangular or other geometric shapes.

5. The passive matrix display of claim 1, wherein said the heights of microstructures are equal to or smaller than a cell gap.

6. The passive matrix display of claim 1, wherein said microstructures act as spacers, alignment layers, and/or banks.

7. The passive matrix display of claim 1, wherein said microstructures are arranged in the same direction.

8. The passive matrix display of claim 1, further comprising an alignment layer disposed on said conductive layer.

9. The passive matrix display of claim 1, further comprising a color filter layer formed between said microstructures.

10. The passive matrix display of claim 1, further comprising a plurality of polymers is formed by a polymerization and formed a sealed structure by said polymers.

11. The passive matrix display of claim 1, wherein said display medium is a liquid crystal.

12. A passive matrix display manufacture method, comprising the steps of:
providing an upper substrate and a lower substrate;
producing a plurality of microstructures on said upper substrate, lower substrates or both;
forming a conductive layer between said microstructures on a residual layer;
assembling said upper and lower substrates such that a gap is formed between the microstructures of the upper substrate and the microstructures of the lower substrate; and
filling a plurality of display media on a cell gap.

13. The passive matrix display manufacture method of claim 12, wherein said upper and lower substrates are glass substrates or flexible substrates.

14. The passive matrix display manufacture method of claim 12, wherein said microstructures are produced by photo or heat polymerization, printing, or embossing.

15. The passive matrix display manufacture method of claim 12, wherein said microstructures are a plurality of non-continuous microstructures or a plurality of continuous microstructures.

16. The passive matrix display manufacture method of claim 15, wherein said non-continuous microstructures are circular, rectangular or other geometric shapes.

17. The passive matrix display manufacture method of claim 15, wherein said microstructures are not sealed and said display media can flow therein.

18. The passive matrix display manufacture method of claim 12, wherein the heights of said microstructures are equal to or smaller than a cell gap.

19. The passive matrix display manufacture method of claim 12, wherein said microstructure acts as spacers, alignment layers, and/or banks.

20. The passive matrix display manufacture method of claim 12, wherein said microstructures are arranged in the same direction.

21. The passive matrix display manufacture method of claim 12, wherein said conductive layer is formed by sputtering or inkjet printing on a substrate.

22. The passive matrix display manufacture method of claim 13, further comprising an alignment layer disposed on said conductive layer.

23. The passive matrix display manufacture method of claim 13, further comprising a color filter layer formed between said microstructures.

24. The passive matrix display manufacture method of claim 23, wherein said color filter layer is produced by an inkjet process.

25. The passive matrix display manufacture method of claim 12, further comprising a plurality of polymers is formed by a polymerization and formed a sealed structure by said polymers.

26. The passive matrix display manufacture method of claim 13, wherein said display medium is a liquid crystal.

27. A passive matrix display manufacture method, comprising the steps of:
providing an upper substrate and a lower substrate;
producing a plurality of microstructures on said upper substrate, lower substrate or both;
forming a conductive layer between said microstructures;
filling a plurality of display media on a cell gap; and
assembling said upper and lower substrates.

28. The passive matrix display manufacture method of claim 27, wherein said upper and lower substrates are glass substrates or flexible substrates.

29. The passive matrix display manufacture method of claim 27, wherein said microstructures are produced by photo or heat polymerization, printing or embossing.

30. The passive matrix display manufacture method of claim 27, wherein said microstructures are a plurality of non-continuous microstructures or a plurality of continuous microstructures.

31. The passive matrix display manufacture method of claim 30, wherein said non-continuous microstructures are circular, rectangular or other geometric shapes.

32. The passive matrix display manufacture method of claim 30, wherein said microstructures are not sealed and said display media can flow therein.

33. The passive matrix display manufacture method of claim 27, wherein the heights of said microstructures are equal to or smaller than a cell gap.

34. The passive matrix display manufacture method of claim 27, wherein said microstructure acts as spacers, alignment layers, and/or banks.

35. The passive matrix display manufacture method of claim 27, wherein said microstructures are arranged in the same direction on a substrate.

36. The passive matrix display manufacture method of claim 27, wherein said conductive layer is formed by sputtering or inkjet printing.

37. The passive matrix display manufacture method of claim 27, further comprising an alignment layer disposed on said conductive layer.

38. The passive matrix display manufacture method of claim 27, further comprising a color filter layer formed on said microstructures.

39. The passive matrix display manufacture method of claim 38, wherein said color filter layer is produced by an inkjet process.

40. The passive matrix display manufacture method of claim 27, wherein said step of filling a plurality of display media in said gap is achieved by an ODF method or a coating method.

41. The passive matrix display manufacture method of claim 27, wherein said display medium is the liquid crystal.

42. The passive matrix display manufacture method of claim 27, further comprising a step of producing a plurality of polymers by a polymerization and form a sealed structure by said polymers.
